(19) United States
(12) Patent Application Publication
(10) Pub. No.: US 2018/0128726 A1
(43) Pub. Date: May 10, 2018

(54) ANALYSIS APPARATUS

(71) Applicant: Industrial Technology Research Institute, Hsinchu (TW)

(72) Inventors: Yen-Liang Lin, Taichung City (TW); Sheng-Hann Wang, Pingtung County (TW); Yu-Shan Yeh, Hsinchu County (TW); Hsin-Chia Ho, Hsinchu County (TW); Wei-En Fu, Taoyuan City (TW)

(73) Assignee: Industrial Technology Research Institute, Hsinchu (TW)

(21) Appl. No.: 15/393,267

(22) Filed: Dec. 29, 2016

(30) Foreign Application Priority Data
Nov. 4, 2016 (TW) 105135837

(51) Int. Cl. G01N 15/02; G01N 23/223

(52) U.S. Cl. CPC G01N 15/02; G01N 23/223; G01N 2223/307; G01N 2015/0288; G01N 2223/313; G01N 2223/641; G01N 2223/309

(57) ABSTRACT

According to an embodiment of the present disclosure, an analysis apparatus may include a movable carrier, a sample providing device and a first analysis device. The movable carrier has at least one sample carry region, and moves the sample carry region to at least one collection position and an analysis position. The sample providing device provides a plurality of samples, wherein the sample carry region receives a portion of the samples at the collection position. The first analysis device may be aligned to the analysis position, and analyzes the samples on the sample carry region located at the analysis position.

### CROSS-REFERENCE TO RELATED APPLICATION

This application claims the priority benefits of a Taiwan application serial no. 105135837, filed on Nov. 4, 2016. The entirety of the above-mentioned patent application is hereby incorporated by reference herein.

### TECHNICAL FIELD

The technical field relates to an analysis apparatus.

### BACKGROUND

There are a wide variety of abrasives used in the semiconductor industry. The particle size distribution and ingredient of the abrasive have significant influence on the result of process. Commonly adopted instruments for analyzing ingredient may include, for example, Mass Spectrometry (MS), X-ray Fluorescence Spectrometer (XRF), Inductively Coupled Plasma Optical Emission Spectrometer (ICP-OES), Energy-Dispersed X-ray Spectroscopy (EDS), Fourier Transform Infrared Spectroscopy (FTIR), Auger Electron Spectroscopy (AES), Secondary Ion Mass Spectrometer (SIMS), X-ray Photoelectron Spectroscopy (XPS), etc. The detection limit of XRF may be lower than that of MS, however, XRF provides a fast and non-destructive method for measuring substances with the advantages of being inexpensive and small in size. Take the current XRF for commercial use as an example, both of the hand-held type and desktop type are used mainly for measuring the ingredient of overall samples. It has become an issue of the field to find out how to integrate an ingredient analysis device with a sample providing device having particle filtering function for use in online real-time analysis.

### SUMMARY

One of exemplary embodiments provides an analysis apparatus. The analysis apparatus may integrate an ingredient analysis device with a sample providing device.

One of exemplary embodiments comprises an analysis apparatus which includes a movable carrier, a sample providing device and a first analysis device. The movable carrier has at least one sample carry region, and moves the sample carry region to at least one collection position and an analysis position. The sample providing device provides a plurality of samples, wherein the sample carry region receives a portion of the samples at the collection position. The first analysis device is aligned to the analysis position, and analyzes the samples on the sample carry region disposed at the analysis position.

One of exemplary embodiments comprises an analysis apparatus which includes a carrier, a sample providing device, a first analysis device and a cleaning device. The carrier has at least one sample carry region. The sample providing device provides a plurality of samples, wherein the sample carry region receives a portion of the samples. The first analysis device is aligned to an analysis position, and analyzes the samples on the sample carry region. The cleaning device cleans the sample carry region.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram illustrating an analysis apparatus according to one embodiment of the disclosure.

FIG. 2 illustrates a structure of a sample providing device in FIG. 1.

FIG. 3 illustrates a structure in which the analysis apparatus in FIG. 1 is on the carrier.

FIG. 4 illustrates operation of a first analysis device in FIG. 3.

FIG. 5 illustrates a structure of a second analysis device in FIG. 1.

FIG. 6 illustrates a structure of an analysis apparatus at a carrier according to another embodiment of the disclosure.

FIG. 7 illustrates a partial structure of the analysis apparatus in FIG. 6.

FIG. 8 illustrates a structure of an analysis apparatus at a carrier according to another embodiment of the disclosure.

FIG. 9 illustrates a structure of an analysis apparatus at a carrier according to another embodiment of the disclosure is on the carrier.

FIG. 10 is a block diagram illustrating an analysis apparatus according to another embodiment of the disclosure.

FIG. 11A illustrates particle size distribution information acquired from an analysis of alumina nanoparticles performed by using the analysis apparatus in the above embodiments of the disclosure.

FIG. 11B illustrates aluminum peak signals of three different concentrations acquired from an analysis of alumina nanoparticles performed by using the analysis apparatus in the above embodiments of the disclosure.

### DESCRIPTION OF EMBODIMENTS

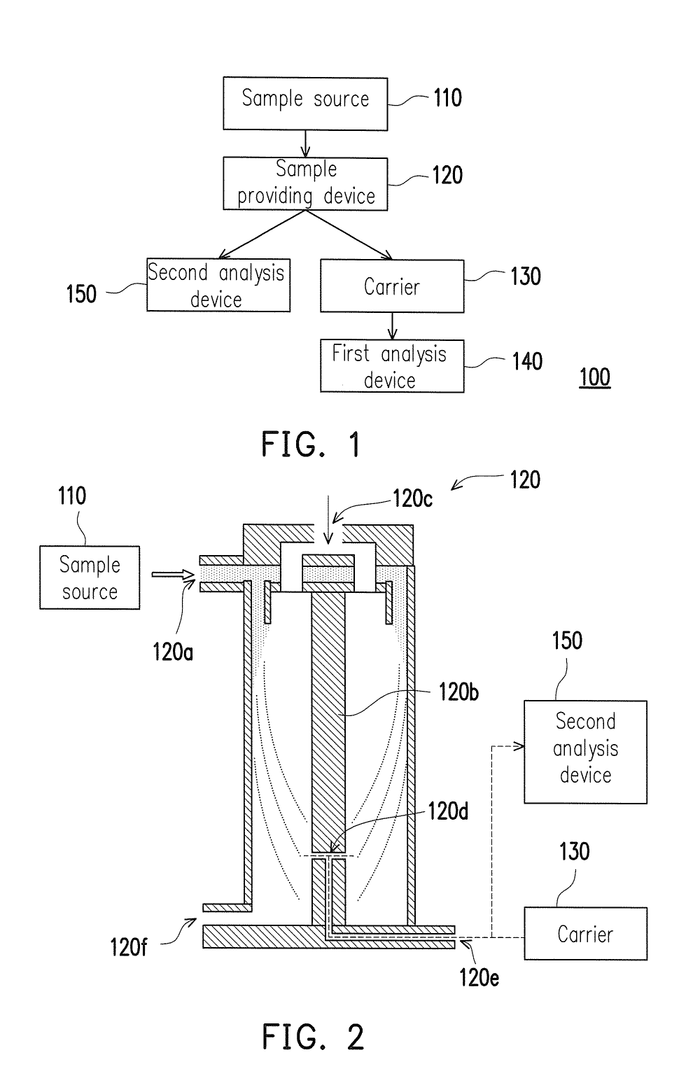

FIG. 1 is a block diagram illustrating an analysis apparatus according to one embodiment of the disclosure. Referring to FIG. 1, an analysis apparatus 100 of the embodiment may include a sample source 110, a sample providing device 120, a carrier 130, a first analysis device 140 and a second analysis device 150.

The sample source 110 includes, for example, but not limited to aerosol particle source. The aerosol particles are obtained, for example, from the environment, or acquired by aerosolizing solution containing particles using an aerosolization device. The aerosolization device is, for example, but not limited to electrospray, ultrasonic atomizer and twin-fluid atomizer.

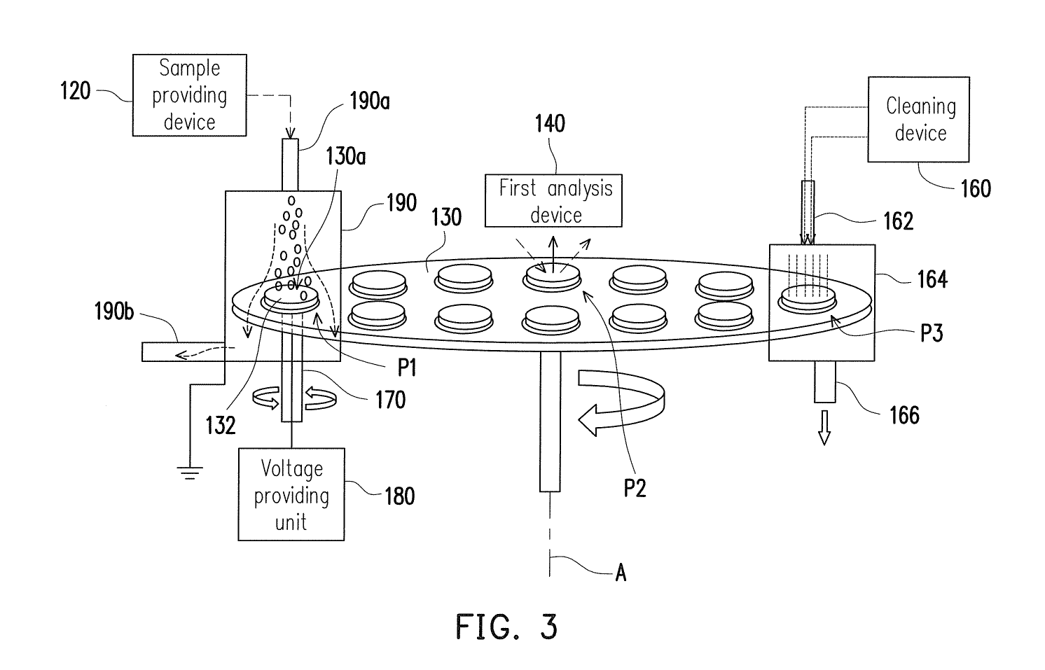

The sample providing device 120 is, for example, but not limited to a particle filtering device for receiving a plurality of samples (e.g. the aerosol particles) from the sample source 110, filtering the samples according to the particle sizes, and subsequently providing the filtered samples to the carrier 130 and the second analysis device 150. FIG. 2 illustrates a structure of a sample providing device in FIG. 1. As shown in FIG. 2, the sample providing device 120 of the embodiment is exemplified as a Scanning Mobility Particle Sizer (SMPS). The samples from the sample source 110 enter an electrode region 120b is via an electricity applying region 120a, and move downwards by being driven via high flow of sheath gas from a sheath fluid introducing port 120c. Since the samples with different particle sizes have different mobilities, by adjusting the voltage in the electrode region 120b, the sample with particular mobility moves to a mobility filtering channel 120d to be collected. The selected samples are delivered to the carrier 130 and the second analysis device 150 respectively by a filtered sample outlet 120e. Extra sheath gas and samples will be discharged via an extra fluid discharging port 120f. In other embodiments, the sample providing device 120 may be an aerosol impactor, a cyclone screener, an ultrasonic autosiever and a filter, the disclosure provides no limitation thereto.

FIG. 3 illustrates a structure in which the analysis apparatus in FIG. 1 is on the carrier. The carrier 130 of the embodiment is a movable carrier and has at least one sample carry region 130a. Referring to FIG. 3, the carrier 130 may have a plurality of carry units 132 for carrying samples, for example. The sample carry regions 130a may be respectively located at carry surfaces of the carry units 132. The particle filtering device provides the filtered sample to the sample carry region 130a for the sample carry region 130a to carry the sample. The carrier 130 rotates along a rotation axis A to move each carry unit 132 and corresponding sample carry region 130a to pass by a collecting position P1, an analysis position P2 and/or a cleaning position P3.

The sample carry region 130a of each carry unit 132 receives the samples at the collecting position P1. The first analysis device 140 is, for example, X-ray Fluorescence Spectrometer (XRF) or other non-destructive ingredient analysis device, aligned to the analysis position P2, and analyzes the elements of the samples on the sample carry region 130a disposed at the analysis position P2. In other embodiments, the first analysis device 140 may be Energy-Dispersed X-ray Spectroscopy (EDS), Auger Electron Spectroscopy (AES), X-ray Photoelectron Spectroscopy (XPS) and Secondary Ion Mass Spectrometer (SIMS), etc., which should not be construed as a limitation to the disclosure.

With such configuration, the first analysis device 140 and sample providing device 120 share the carrier 130 to achieve the effect of integration. The first analysis device 140 can analyze samples from the sample providing device 120 in real time so that the operation efficiency of the production line or monitoring system that uses the analysis apparatus 100 could be improved. In addition, the analysis apparatus 100 further includes a cleaning device 160. The cleaning device 160 cleans the sample carry region 130a at the cleaning position P3. Therefore, the sample carry region 130a could be used repeatedly to further enhance operation efficiency of the analysis apparatus 100.

The operation of collecting the sample is described in details below. As shown in FIG. 3, the analysis apparatus 100 further includes a driving unit 170. The driving unit 170 is, for example, a drive shaft and is aligned to the collecting position P1 as well as driving the corresponding carry unit 132 to rotate, such that the sample can be more evenly distributed on the sample carry region 130a on the carry unit 132. The analysis apparatus 100 further includes a voltage providing unit 180. The voltage providing unit 180 is aligned to the collection position P1, and provides voltage to the sample carry region 130a so that the sample carry region 130a generates static electricity to effectively draw the samples. In addition, the analysis apparatus 100 further includes a cover 190. The cover 190 covers the carry unit 132 and sample carry region 130a to prevent the samples from scattering to other position. The cover 190 has an inlet 190a and an outlet 190b. The samples are provided to the sample carry region 130a through the inlet 190a via a guiding airflow, and the guiding airflow leaves the cover 190 via the outlet 190b.

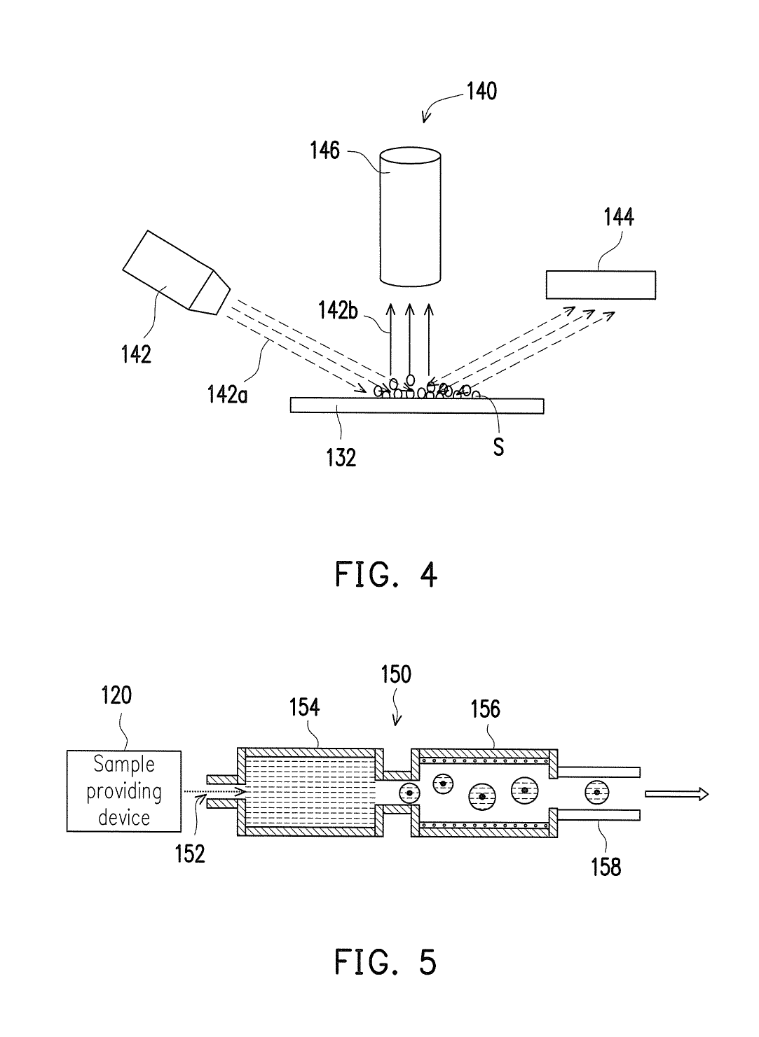

The operation of analyzing the sample is described in details below. FIG. 4 illustrates operation of the first analysis device in FIG. 3. The X-ray Fluorescence Spectrometer (XRF) is incorporated in the exemplary descriptions. Referring to FIG. 4, an X-ray source 142 generates X-ray 142a. The X-ray 142a focuses on a collected sample S on the sample carry region 130a and stops until being reflected to a stop 144. During the process, the collected samples S are excited to ionize and emit a feature X-ray, i.e. X-ray fluorescence 142b. The samples S releases the X-ray fluorescence 142b, which is received by a fluorescence detector 146 and processed as well as analyzed by signal, thereby acquiring the elements of the samples S to be tested.

The operation of cleaning the sample carry region is described in details below. As shown in FIG. 3, a cleaning agent provided by the cleaning device 160 enters a cleaning cavity 164 via a pipeline 162 to clean the carry unit 132 and sample carry region 130a accommodated in the cleaning cavity 164. The used cleaning agent is discharged via a discharging pipe 166.

In the embodiment, the samples provided by the sample providing device 120 are collected on the carrier 130 and analyzed by the first analysis device 140. Apart from that, a portion of the samples may be guided to the second analysis device 150 illustrated in FIG. 1 for analysis. In the embodiment, the second analysis device 150 is, for example, a condensation particle counter. The condensation particle counter makes fine aerosol particles to pass through a particular saturation vapor to be condensed so that the samples can be covered by a thicker shell to be detected and analyzed by an optical counter.

FIG. 5 illustrates a structure of the second analysis device in FIG. 1. Referring to FIG. 5, the samples (e.g. aerosol particles) filtered by the sample providing device 120 is delivered to an aerosol particles introducing port 152 of a saturation vapor cavity 154, and the saturation vapor for covering the shell is filled in the saturation vapor cavity 154. The surface of the sample absorbs vapor after passing through the saturation vapor cavity 154. Subsequently, the vapor absorbed by the samples when passing through a condenser 156 is condensed into a shell so that it is easy for a light detecting module 158 to detect the samples and perform quantitative statistical analysis on the samples. The samples, for example, flow by being driven via a pump connected with an outlet end of the second analysis device 150 or other suitable driving unit, which should not be construed as a limitation to the disclosure. With a combination of the sample providing device 120 (e.g. Scanning Mobility Particle Sizer (SMPS)) and the second analysis device 150 (e.g. condensation particle counter), the particle size distribution and relative quantity concentration of the samples can be acquired. In other embodiments, the second analysis device 150 may be an Optical Particle Counter (OPC), an Aerosol Electrometer (AE), a Single Particle Inductively Coupled Plasma Mass Spectrometer (SPICP-MS), a Scanning Electron Microscope (SEM), etc., the disclosure provides no limitation thereto.

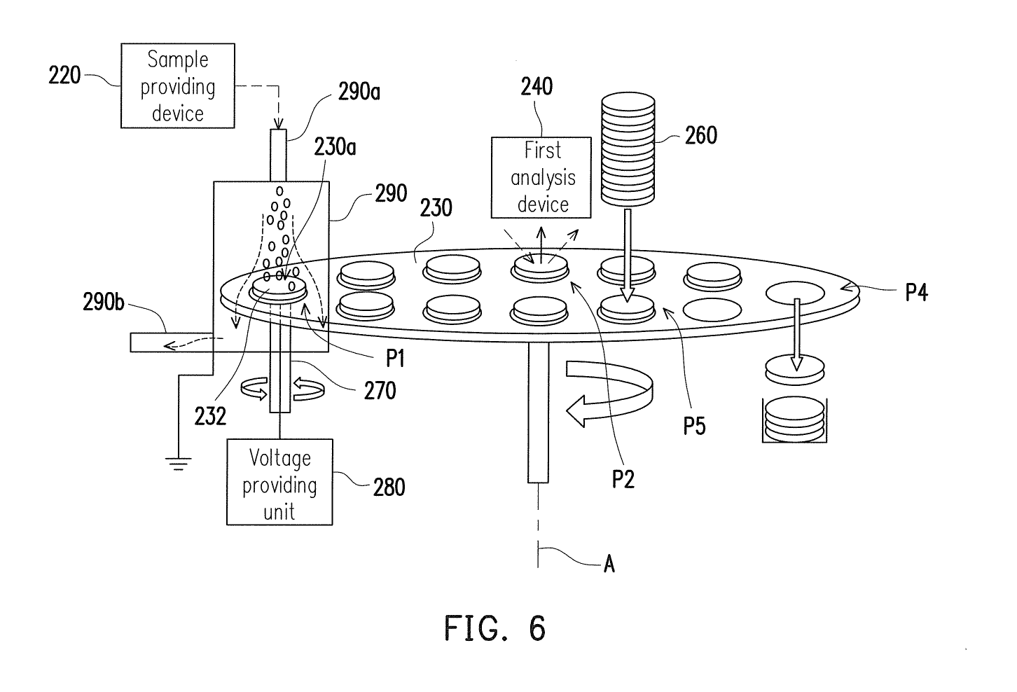

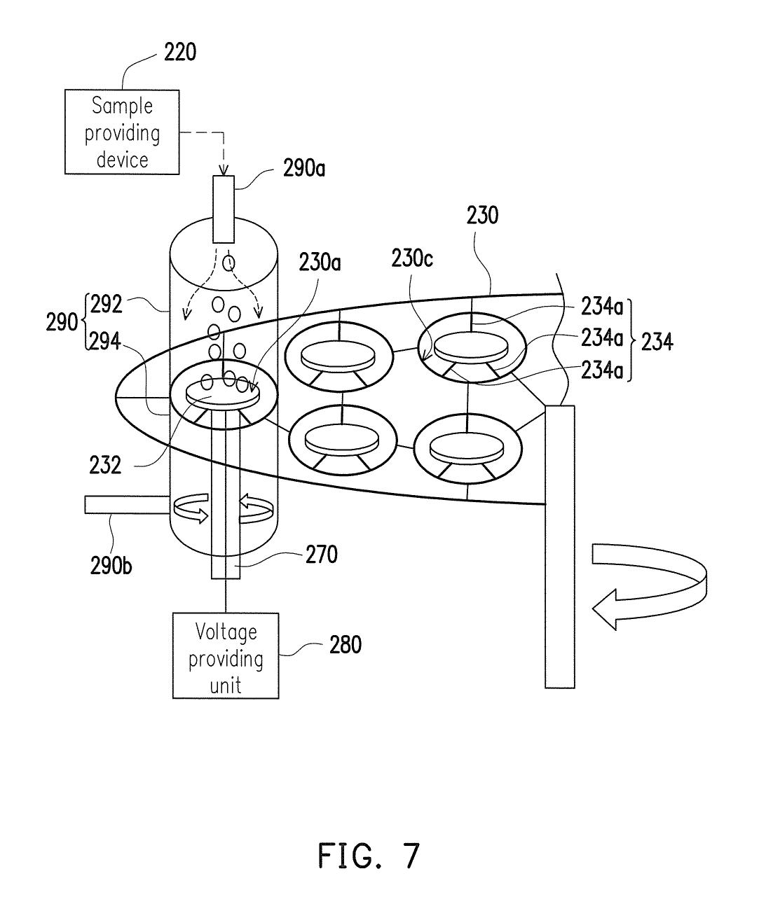

FIG. 6 illustrates a structure of an analysis apparatus at a carrier according to another embodiment of the disclosure. In the embodiment illustrated in FIG. 6, the configuration and operation of a sample providing device 220, a carrier 230, a carry unit 232, a sample carry region 230a, a first analysis device 240, a driving unit 270, a voltage providing unit 280, a cover 290, an inlet 290a and an outlet 290b are similar to the configuration and operation of the sample providing device 120, carrier 130, carry unit 132, sample carry region 130a, first analysis device 140, driving unit 170, voltage providing unit 180, cover 190, inlet 190a, outlet 190b illustrated in FIG. 3; thus, no repetition is incorporated herein. As shown in FIG. 6, the carry unit 232 or sample carry region 230a on the carrier 230 is supplemented through the means of replacement. The carrier 230 illustrated in FIG. 6 moves the used carry unit 232 or sample carry region 230a to an unloading position P4. The used carry unit 232 or sample carry region 230a is unloaded at the unloading position P4. Correspondingly, the analysis apparatus in FIG. 6 includes a loading unit 260. The loading unit 260 loads the carry unit 232 or sample carry region 230a that is usable subsequently to the carrier 230 at a loading position P5.

FIG. 7 illustrates a partial structure of the analysis apparatus in FIG. 6. As shown in FIG. 7, the carrier 230 has a plurality sets of unloading mechanisms 234. The unloading mechanism 234 is configured in an opening 230c of the carrier 230 and holds the carry unit 232, and releases the carry unit 232 at the unloading position P4 in FIG. 6 so that the carry unit 232 is detached from the carrier 230 and falls automatically. For example, as shown in FIG. 7, each unloading mechanism 234 is constituted by a plurality of retractable rods 234a (exemplified in the number of 3). The retractable rods 234a may retract to hold or release the carry unit 232.

Referring to FIG. 7, in the embodiment, an inlet 290a and outlet 290b of the cover 290 are respectively disposed on two opposite sides of the opening 230c of the carrier 230. The guiding airflow from the inlet 290a passes through the opening 230c and move toward the outlet 290b. In addition, the cover 290 in the embodiment includes an upper cover 292 and a lower cover 294. As shown in FIG. 7, the upper cover 292 and lower cover 294 are closed to the two opposite sides of the opening 230c respectively to cover the sample carry region 230a on the carry unit 232 together. Meanwhile, the upper cover 292 and lower cover 294 may be separated from the opening 230c so the carrier 230 can rotate.

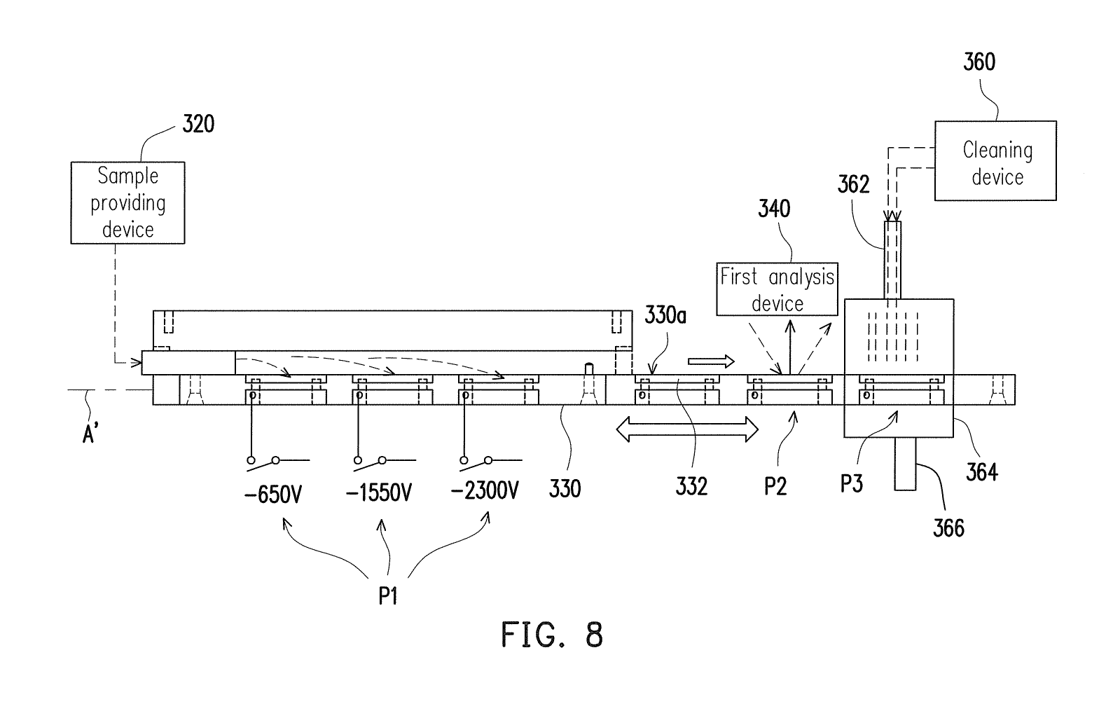

FIG. 8 illustrates a structure of an analysis apparatus at a carrier according to another embodiment of the disclosure. In the embodiment illustrated in FIG. 8, the configuration and operation of a sample providing device 320, a carrier 330, a sample carry region 330a, a carry unit 332, a first analysis device 340, a cleaning device 360, a pipeline 162, a cleaning cavity 364, a discharging pipe 366 are similar to the configuration and operation of the sample providing device 120, carrier 130, sample carry region 130a, carry unit 132, first analysis device 140, cleaning device 160, pipeline 162, cleaning cavity 164 and discharging pipe 166 in FIG. 3; thus, no repetition is incorporated herein. As shown in FIG. 8, the carrier 330 may be translated in a reciprocating mariner. The carrier 330 moves reciprocatingly along a translating axis A′ to drive the sample carry region 330a to move along the translating axis A′ to the collection position P1, analysis position P2 and/or cleaning position P3. In addition, the number of collection position P1 in FIG. 8 may be plural. The carrier 330 provides different voltage (shown in −650V, −1550V and −2300V as example) to the collection positions P1 respectively, such that the samples with different particle sizes can be collected to the collection positions P1 respectively via different static electricity.

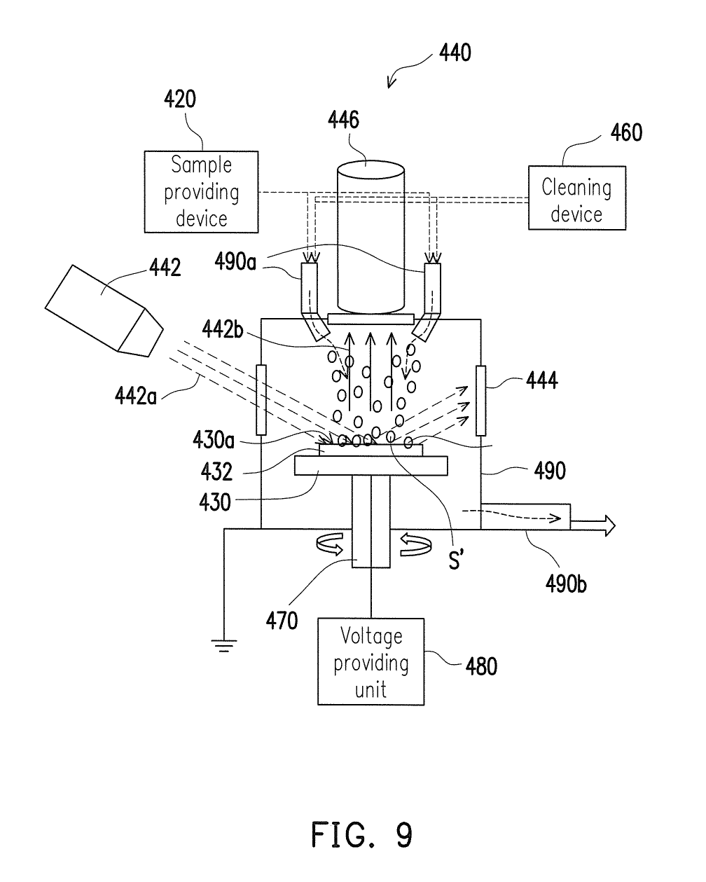

FIG. 9 illustrates a structure of an analysis apparatus at a carrier according to another embodiment of the disclosure. In the embodiment illustrated in FIG. 9, the configuration and operation of a sample providing device 420, a carrier 430, a sample carry region 430a, a carry unit 432, a first analysis device 440, an X-ray source 442, an X-ray 442a, an X-ray fluorescence 442b, a sample S′, a stop 444, a fluorescence detector 446, a cleaning device 460, a driving unit 470, a voltage providing unit 480, a cover 490, an inlet 490a and an outlet 490b are similar to the configuration and operation of the sample providing device 120, carrier 130, sample carry region 130a, carry unit 132, first analysis device 140, X-ray source 142, X-ray 142a, X-ray fluorescence 142b, sample S, stop 144, fluorescence detector 146, cleaning device 160, driving unit 170, voltage providing unit 180, cover 190, inlet 190a and outlet 190b in FIGS. 3-4; thus, no repetition is incorporated herein. As shown in FIG. 9, the carrier 430 may be a fixed carrier. In addition, the inlet 490a of the cover 490 not only introduces the samples S′ to enter the inside of the cover 490, the cleaning device 460 also provides cleaning agent to the sample carry region 430a via the inlet 490a. In other embodiments, the cleaning device 460 may provide the cleaning agent to the sample carry region 430a via a channel different from the inlet 490a; the disclosure provides no limitation thereto.

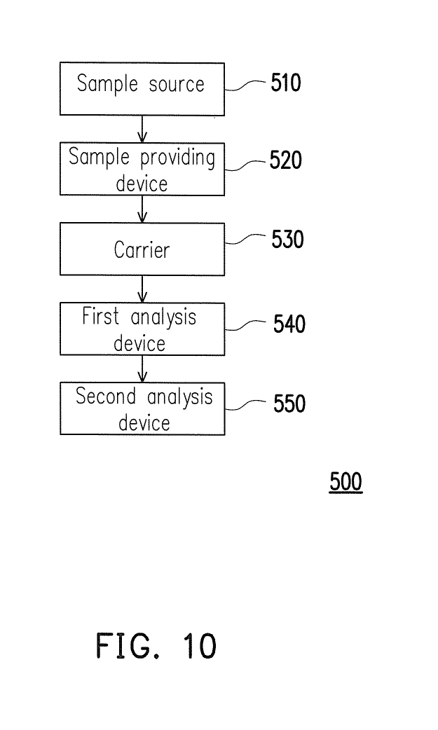

FIG. 10 is a block diagram illustrating an analysis apparatus according to another embodiment of the disclosure. In an analysis apparatus 500 in FIG. 10, the operation of a sample source 510, sample providing device 520, carrier 530, first analysis device 540 and second analysis device 550 is similar to the operation of the sample source 110, sample providing device 120, carrier 130, first analysis device 140 and second analysis device 150 in FIG. 1; thus, no repetition is incorporated herein. The second analysis device 550 of the analysis apparatus 500 may be connected behind the first analysis device 540. In other words, a portion of the samples from the sample providing device 520 will reach the second analysis device 550 after passing the carrier 530 and first analysis device 540.

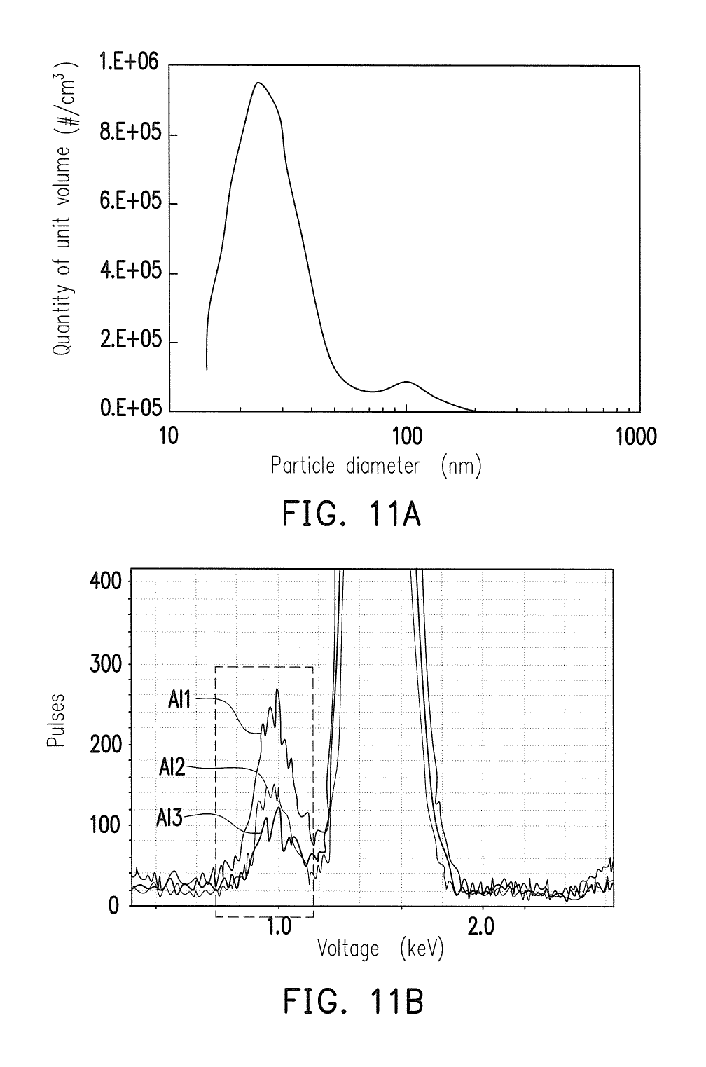

FIG. 11A illustrates particle size distribution information acquired from an analysis of alumina nanoparticles performed by using the analysis apparatus in the above embodiments of the disclosure. FIG. 11B illustrates aluminum peak signals of three different concentrations acquired from an analysis of alumina nanoparticles performed by using the analysis apparatus in the above embodiments of the disclosure. FIG. 11A shows that the analysis apparatus described in the embodiments above can indeed analyze the unit volume distribution of the particles with various particle sizes in the alumina nanoparticles samples. Meanwhile, in FIG. 11B, the aluminum peak signals Al1, Al2 and Al3 in the dashed-line frame show that the analysis apparatus described in the embodiments above can indeed analyze the difference in the content of aluminum element in the alumina nanoparticle samples with three different concentrations. The analysis apparatus described in the embodiments above may also be used to analyze other types of samples; the disclosure provides no limitation thereto.

In the analysis apparatus described in the embodiments of the disclosure, the sample carry region on the carrier may receive samples from the sample providing device, and the first analysis device may perform analysis to the sample on the sample carry region. That is, the first analysis device (e.g. ingredient analysis device) and sample providing device (e.g. particle filtering device) share the carrier to achieve the integration effect. The first analysis device can analyze sample from the sample providing device in real time, such that the operation efficiency of the production line or a monitoring system that uses the analysis apparatus could be improved. In addition, the carrier may be a movable carrier so that the sample carry region can be driven by the movable carrier to move to the collection position automatically to collect the samples, and move to the analysis position automatically to perform analysis to the samples. In addition, the analysis apparatus can use the cleaning device to clean the used sample carry region so the sample carry region could be used repeatedly to further enhance operation efficiency of the analysis apparatus.

It will be clear that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An analysis apparatus, comprising:
a movable carrier, comprising at least one sample carry region, and moving the sample carry region to at least one collection position and an analysis position;
a sample providing device, providing a plurality of samples, wherein the sample carry region receives a portion of the samples at the collection position; and
a first analysis device, aligned to the analysis position, and analyzing the samples on the sample carry region at the analysis position.

2. The analysis apparatus according to claim 1, wherein the sample providing device is a particle filtering device, the particle filtering device performs filtering according to particle sizes of the samples and provides the filtered samples to the sample carry region.

3. The analysis apparatus according to claim 1, wherein the movable carrier rotates along a rotation axis to drive the sample carry region to move about the rotation axis to the collection position or the analysis position.

4. The analysis apparatus according to claim 1, wherein the movable carrier moves reciprocatingly along a translating axis to drive the sample carry region to move along the translating axis to the collection position or the analysis position.

5. The analysis apparatus according to claim 1, wherein the movable carrier further comprises at least one carry unit, the carry unit comprises a carry surface, and the sample carry region is located at the carry surface.

6. The analysis apparatus according to claim 5, wherein the number of the at least one carry unit is plural, the movable carrier moves each of the carry units to pass the collection position or the analysis position.

7. The analysis apparatus according to claim 5, wherein the movable carrier moves the carry unit to an unloading position, the carry unit is unloaded at the unloading position.

8. The analysis apparatus according to claim 7, wherein the movable carrier comprises at least one unloading mechanism, the unloading mechanism holds the carry unit and releases the carry unit at the unloading position such that the carry unit can be detached from the movable carrier.

9. The analysis apparatus according to claim 5, comprising a loading unit, wherein the loading unit loads the carry unit at a loading position to the movable carrier.

10. The analysis apparatus according to claim 5, comprising a driving unit, wherein the driving unit is aligned to the collection position and drives the carry unit to rotate.

11. The analysis apparatus according to claim 1, comprising a voltage providing unit, wherein the voltage providing unit is aligned to the collection position, and provides voltage to the sample carry region so that the sample carry region generates static electricity.

12. The analysis apparatus according to claim 1, comprising a cover, wherein the cover covers the sample carry region and comprises an inlet, the samples are provided to the sample carry region via the inlet.

13. The analysis apparatus according to claim 12, wherein the cover comprises an outlet, the samples are provided to the sample carry region via a guiding airflow, the guiding airflow leaves the cover via the outlet.

14. The analysis apparatus according to claim 13, wherein the movable carrier comprises at least one opening, the inlet and the outlet are respectively disposed at two opposite sides of the opening, the guiding airflow from the inlet passes through the opening to move toward the outlet.

15. The analysis apparatus according to claim 14, wherein the cover comprises an upper cover and a lower cover, the upper cover and the lower cover are closed to two opposite sides of the opening respectively to cover the sample carry region together, or the upper cover and the lower cover are separated from the opening.

16. The analysis apparatus according to claim 1, wherein the first analysis device is an ingredient analysis device, the ingredient analysis device analyzes elements of the samples.

17. The analysis apparatus according to claim 1, comprising a cleaning device, wherein the movable carrier moves the sample carry region to a cleaning position, the cleaning position cleans the sample carry region at the cleaning position.

18. The analysis apparatus according to claim 1, wherein the number of the at least one collection position is plural, the movable carrier provides different voltages to the collection positions respectively so that the samples having different particle sizes are respectively collected to the collection positions.

19. The analysis apparatus according to claim 1, further comprising a second analysis device, wherein the second analysis device is different from the first analysis device and receives and analyzes a portion of the samples from the sample providing device.

20. An analysis apparatus, comprising:
a carrier, comprising at least one sample carry region;
a sample providing device, providing a plurality of samples, wherein the sample carry region receives a portion of the samples;
a first analysis device, aligned to an analysis position, and analyzing the samples on the sample carry region; and
a cleaning device, cleaning the sample carry region.

21. The analysis apparatus according to claim 20, wherein the sample providing device is a particle filtering device, the particle filtering device performs filtering according to particle sizes of the samples and provides the filtered samples to the sample carry region.

22. The analysis apparatus according to claim 20, wherein the carrier is a movable carrier and moves the sample carry region to at least one collection position, an analysis position or a cleaning position, the sample carry region receives a portion of the samples at the collection position, the first analysis device analyzes the samples on the sample carry region at the analysis position, the cleaning device cleans the samples on the sample carry region at the cleaning position.

23. The analysis apparatus according to claim 22, wherein the movable carrier rotates along a rotation axis to drive the sample carry region to move about the rotation axis to the collection position, the analysis position or the cleaning position.

24. The analysis apparatus according to claim 22, wherein the movable carrier moves reciprocatingly along a translating axis to drive the sample carry region to move along the translating axis to the collection position, the analysis position or the cleaning position.

25. The analysis apparatus according to claim 20, wherein the carrier further comprises at least one carry unit, the carry unit comprises a carry surface, the sample carry region is located at the carry surface.

26. The analysis apparatus according to claim 25, wherein the number of the at least one sample carry region is plural, the carrier is a movable carrier and moves each of the carry units.

27. The analysis apparatus according to claim 25, comprising a driving unit, wherein the driving unit drives the carry unit to rotate.

28. The analysis apparatus according to claim 20, comprising a voltage providing unit, wherein the voltage providing unit provides voltage to the sample carry region so that the sample carry region generates static electricity.

29. The analysis apparatus according to claim 20, comprising a cover, wherein the cover covers the sample carry region and comprises an inlet, the samples are provided to the sample carry region via the inlet.

30. The analysis apparatus according to claim 29, wherein the cover comprises an outlet, the samples are provided to the sample carry region via a guiding airflow, the guiding airflow leaves the cover via the outlet.

31. The analysis apparatus according to claim 29, wherein the cleaning device provides cleaning agent to the sample carry region via the inlet.

32. The analysis apparatus according to claim 20, wherein the first analysis device is an ingredient analysis device, the ingredient analysis device analyzes elements of the samples.

33. The analysis apparatus according to claim 20, wherein the carrier comprises a plurality of collection positions, and provides different voltages to the collection positions respectively so that the samples having different particle sizes are respectively collected to the collection positions.

34. The analysis apparatus according to claim 20, further comprising a second analysis device, wherein the second analysis device is different from the first analysis device and receives and analyzes a portion of the samples from the sample providing device.
